(19) United States
(12) Patent Application Publication
(10) Pub. No.: US 2013/0076484 A1
(43) Pub. Date: Mar. 28, 2013

(54) WIRELESS COMMUNICATION DEVICE AND COMMUNICATION CONTROL METHOD

(71) Applicant: Tadao Nishiguchi, Aichi (JP)

(72) Inventor: Tadao Nishiguchi, Aichi (JP)

(73) Assignee: OMRON AUTOMOTIVE ELECTRONICS CO., LTD., Aichi (JP)

(21) Appl. No.: 13/618,398

(22) Filed: Sep. 14, 2012

(30) Foreign Application Priority Data
Sep. 26, 2011 (JP) 2011-208484

(51) Int. Cl. G05B 19/00

(52) U.S. Cl. 340/5.64

(57) ABSTRACT

A wireless communication device for a vehicle conducts wireless communication with a vehicle portable key through an antenna including a resonant circuit. The wireless communication device has a transmitting circuit that transmits a signal from the antenna, and a control circuit that supplies an inversion carrier wave in which a phase of a carrier wave is inverted to the transmitting circuit for a predetermined time after a modulated signal in which the carrier wave is modulated by transmission data is transmitted from the antenna.

### BACKGROUND OF THE INVENTION

1. Technical Field

The present invention relates to a wireless communication device and a communication control method and, particularly to a wireless communication device and a communication control method for a vehicle.

2. Related Art

Recently, there is an increase in vehicle on which a system providing a function (hereinafter, referred to as a passive entry), in which a user carries with a dedicated portable key that conducts wireless communication and the user can lock and unlock a door only by gripping a door handle of a vehicle or operating a switch near the door handle, is mounted.

Conventionally, in a passive entry system disclosed in Japanese Unexamined Patent Publication No. 9-128905, for example, an antenna is provided in each door of the vehicle, a response request signals are transmitted at different times from the antennas, and the door that the portable key comes close to is detected based on reception timing of a response signal from the portable key.

Conventionally, in addition to each door, the antenna is also provided in the car to detect whether the portable key exists on the inside (including the trunk room) or the outside of the car. When the portable key does not exist on the outside of the car, the door is not unlocked in order to prevent a theft of the vehicle.

In the passive entry system in which a plurality of antennas are provided, it is necessary to strengthen radiation intensity of the response request signal transmitted from each antenna to the portable key in order to sufficiently ensure a detection area of the portable key of each antenna.

Regarding to this, in the case that the radiation intensity of the response request signal is strengthened such that a control resistance is reduced to enhance a Q value without providing a booster circuit or a full-bridge circuit, a certain time is required for rise and fall of a radiation wave due to use of resonance phenomenon.

FIG. 1 illustrates an example of a received waveform of the portable key in the case that the response request signal is transmitted from the antenna provided in an indoor front of the vehicle after the response request signal is transmitted from the antenna provided in a door mirror. In FIG. 1, a time series progresses from the left toward the right.

For example, a preamble, a header, data, and a CW (Continuous Wave) are sequentially transmitted in the response request signal. In FIG. 1, a period T1 is a period necessary for the rise of the CW, and a period until an amplitude reaches a predetermined level (for example, 95% of target value) since the transmission of the CW is started. A period T2 is a period until the transmission of the CW is stopped since the amplitude of the CW reaches the predetermined level, and an RSSI value is measured by the portable key in the period T2. A period T3 is a period necessary for the fall of the CW, and a period until the amplitude of the CW is less than or equal to the predetermined level since the transmission of the CW is stopped. The RSSI value is used to detect a distance between the portable key and the vehicle.

When the transmission of the preamble is started from the antenna in the indoor front of the car before the CW attenuates sufficiently, possibly the portable key fails to receive the preamble due to the influence of the CW. Accordingly, the period T3 is set to a time, in which a theoretical value of an SN ratio of the preamble and the CW is greater than or equal to a predetermined value (for example, 13 dB or more) when the CW is assumed to be a noise and the influence of the CW decreases sufficiently. The transmission of the preamble is started from the antenna in the indoor front of the car after a period T4 in which a predetermined margin time is added to the period T3 elapses since the transmission of the CW is stopped.

On the other hand, in the passive entry system, there is a need to shorten a response time until the door is locked or unlocked since a user operates the door handle or the switch. Accordingly, desirably the period T3 is shortened to shorten a transmission interval of the response request signal between the antennas.

However, when the intensity of the radiation wave is strengthened to increase the Q value in order to widen the detection area of each antenna, the necessary time in which the intensity of the radiation wave converges to a certain level is lengthened to lengthen the period T3.

As used herein, the “Q (Quality factor) value” means sharpness of resonance, and the resonance has sharper, steeper frequency characteristic with increasing Q value. Generally the communication can be conducted better with increasing Q value. However, in the case that the frequency is increased to accelerate a communication rate, reception sensitivity is degraded when the Q value is excessively increased.

For example, Japanese Unexamined Patent Publication No. 2011-10159 discloses a technology in which, in a non-contact communication device that can conduct communication at a plurality of communication rates, the Q value is set smaller with increasing communication rate, whereby non-contact communication can stably be conducted even at the high-speed communication rate. However, the shortening of the convergence time of the radiation wave is not considered in the technology disclosed in Japanese Unexamined Patent Publication No. 2011-10159.

### SUMMARY

One or more embodiments of the present invention accelerates the convergence of the radiation wave transmitted from the antenna in which the resonant circuit is used.

In accordance with one or more embodiments of the present invention, a wireless communication device for a vehicle that conducts wireless communication with a vehicle portable key, includes: a transmitting circuit that transmits a signal from the antenna; and a control circuit that supplies an inversion carrier wave in which a phase of a carrier wave is inverted to the transmitting circuit for a predetermined time after a modulated signal in which the carrier wave is modulated by transmission data is transmitted from the antenna.

In the wireless communication device in accordance with one or more embodiments of the present invention, the inversion carrier wave in which the phase of the carrier wave is inverted is supplied to the transmitting circuit for the predetermined time after the modulated signal in which the carrier wave is modulated by the transmission data is transmitted from the antenna.

Accordingly, the convergence of the radiation wave transmitted from the antenna in which the resonant circuit is used can be accelerated. As a result, for example, the response time of the passive entry can be shortened.

For example, the antenna includes an LF antenna. For example, the transmitting circuit includes an antenna drive circuit that drives the antenna. For example, the control circuit includes control circuits, such as a CPU (Central Processing Unit) and an ECU (Electronic Control Unit).

The wireless communication device may transmit the modulated signal at different times through the plurality of antennas, and the control circuit may supply the inversion carrier wave to the transmitting circuit for the first antenna for a predetermined time before the modulated signal is transmitted through the second antenna after the modulated signal is transmitted through the first antenna.

Therefore, the response time of the passive entry in which the plurality of antennas are used can be shortened.

The control circuit may generate the modulated signal and the inversion carrier wave in which a phase of the carrier wave is inverted, and supply the modulated signal and the inversion carrier wave to the transmitting circuit.

Therefore, the transmitting circuit can be simplified without providing a special function in the transmitting circuit.

The transmitting circuit may generate the inversion carrier wave in response to a command from the control circuit.

Therefore, it is not necessary for the control circuit to generate the inversion carrier wave, but the control circuit can be simplified.

The wireless communication device may further include the antenna.

In accordance with one or more embodiments of the present invention, in a communication control method, a wireless communication device for a vehicle, which includes a transmitting circuit transmitting a signal from an antenna including a resonant circuit and conducts wireless communication with a vehicle portable key through the antenna, supplies an inversion carrier wave in which a phase of a carrier wave is inverted to the transmitting circuit for a predetermined time after a modulated signal in which the carrier wave is modulated by transmission data is transmitted from the antenna.

In the communication control method in accordance with one or more embodiments of the present invention, the inversion carrier wave in which the phase of the carrier wave is inverted is supplied to the transmitting circuit for the predetermined time after the modulated signal in which the carrier wave is modulated by the transmission data is transmitted from the antenna.

Accordingly, the convergence of the radiation wave transmitted from the antenna in which the resonant circuit is used can be accelerated. As a result, for example, the response time of the passive entry can be shortened.

For example, the antenna includes an LF antenna. For example, the transmitting circuit includes an antenna drive circuit that drives the antenna.

According to one or more embodiments of the present invention, the convergence of the radiation wave transmitted from the antenna in which the resonant circuit is used can be accelerated. As a result, for example, the response time of the passive entry can be shortened.

### BRIEF DESCRIPTION OF THE DRAWINGS

FIG. 1 is a view illustrating an example of a received waveform of a portable key in a conventional passive entry system;

FIG. 2 is a block diagram illustrating a passive entry system according to one or more embodiments of the present invention;

FIG. 3 is a block diagram illustrating a detailed configuration example of a transmitter of the passive entry system according to one or more embodiments of the present invention;

FIG. 4 is a view illustrating an example of an installation position of an LF antenna;

FIG. 5 is a diagram illustrating an example of transmission timing of a response request signal and a response signal when a user makes a request to unlock a door using the portable key;

FIG. 6 is a graph of a comparison of a signal inputted to an LF drive circuit and a resonant current passing through the LF antenna between a conventional control method and a control method according to one or more embodiments of the present invention; and

FIG. 7 is a graph of a comparison of the signal inputted to the LF drive circuit and the resonant current passing through the LF antenna between the conventional control method and the control method according to one or more embodiments of the present invention when a plurality of LF antennas are used.

### DETAILED DESCRIPTION

Hereinafter, embodiments of the present invention will be described. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### Configuration Example of Passive Entry System 101

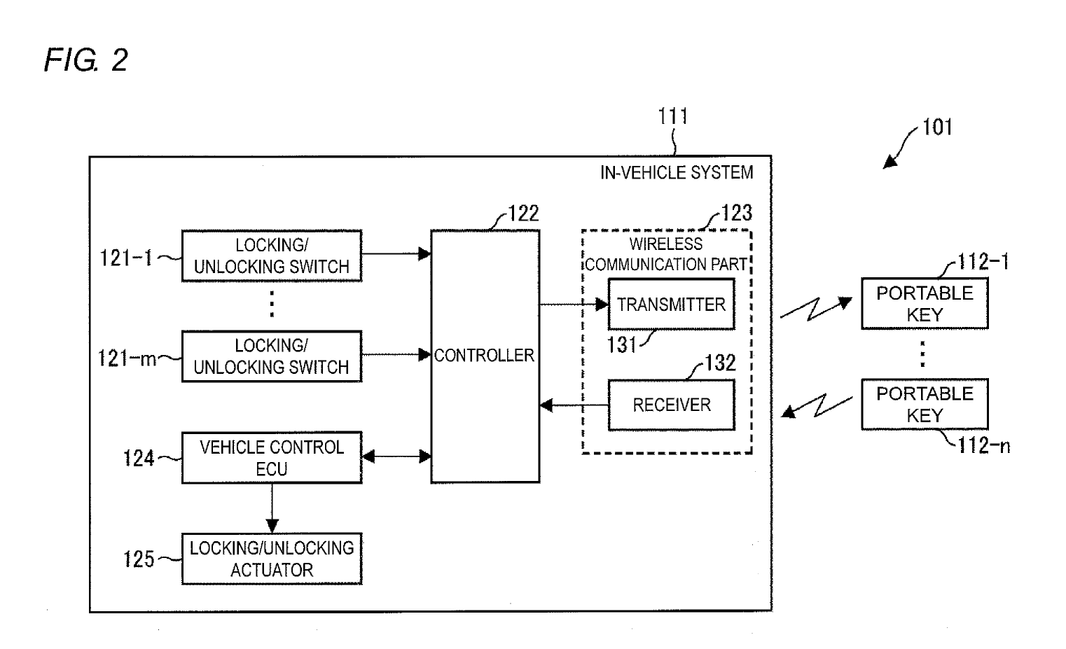

FIG. 2 is a block diagram illustrating a passive entry system according to one or more embodiments of the present invention.

A passive entry system 101 implements a passive entry in which a door is locked and unlocked only by carrying portable keys 112-1 to 112-n to operate locking/unlocking switches 121-1 to 121-m provided near a door handle of a vehicle, for example. The passive entry system 101 includes an in-vehicle system 111 and the portable keys 112-1 to 112-n.

The in-vehicle system 111 is provided on a side of the vehicle on which a passive entry function is mounted. There is no particular limitation to a type of the vehicle in which the in-vehicle system 111 is provided.

The in-vehicle system 111 includes the locking/unlocking switches 121-1 to 121-m, a controller 122, a wireless communication part 123, a vehicle control ECU (Electronic Control Unit) 124, and a locking/unlocking actuator 125.

The locking/unlocking switches 121-1 to 121-m are operated by a user in order to lock or unlock the door of the vehicle. The locking/unlocking switches 121-1 to 121-m supply a predetermined operation signal to a controller 122 when being operated by the user.

Any number of locking/unlocking switches 121-1 to 121-m may be provided, and the locking/unlocking switches 121-1 to 121-m may be installed in any position. For example, the locking/unlocking switches 121-1 to 121-m are provided near door handles of the door on a driver's seat side, the door on an assistant driver's seat side, and the rear door.

Hereinafter, the locking/unlocking switches 121-1 to 121-m are simply referred to as a locking/unlocking switch 121 when there is no need to distinguish the locking/unlocking switches 121-1 to 121-m from one another.

For example, the controller 122 includes control units, such as an ECU and a CPU. The controller 122 controls each part of the in-vehicle system 111 to cause the part to perform processing related to the passive entry.

For example, the wireless communication part 123 includes a wireless communication device that conducts wireless communication with the portable keys 112-1 to 112-n. The wireless communication part 123 includes a transmitter 131 and a receiver 132.

The transmitter 131 transmits a response request signal under the control of the controller 122.

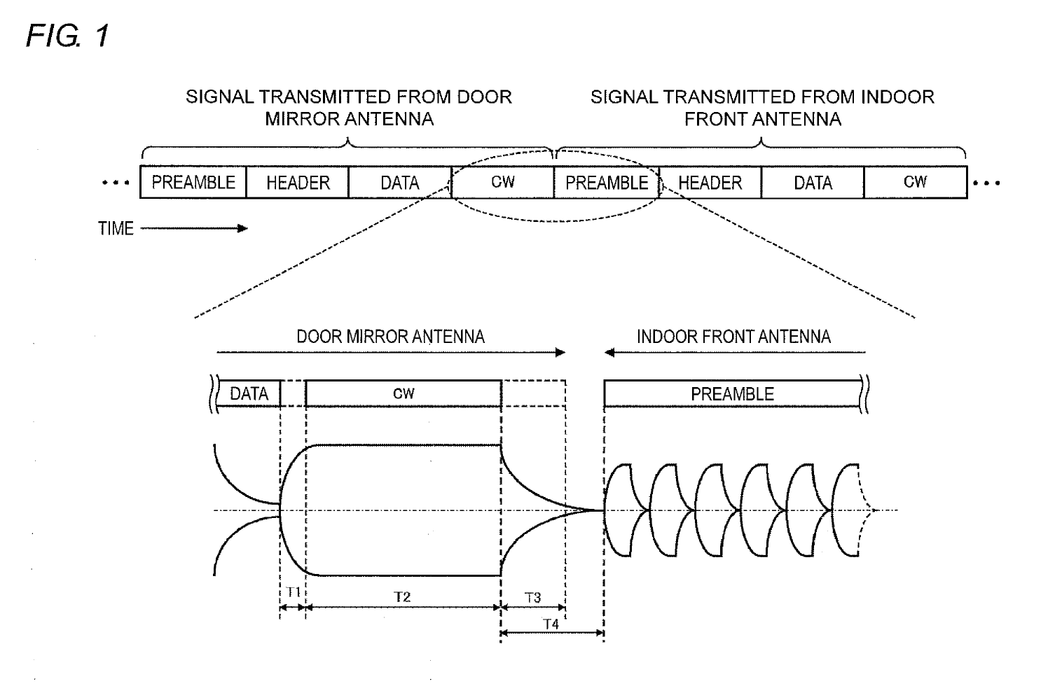

For example, as described above with reference to FIG. 1, the preamble, the header, the data, and the CW are sequentially transmitted in the response request signal. For example, an LF (Low Frequency)-band wireless signal is used as the response request signal.

The receiver 132 receives response signals that are transmitted from the portable keys 112-1 to 112-n in response to the response request signal. The receiver 132 performs pieces of processing, such as demodulation of the received response signal, and supplies the post-processing response signal to the controller 122.

For example, a UHF (Ultra High Frequency)-band wireless signal is used as the response signal.

Under the control of the controller 122, the vehicle control ECU 124 controls the locking/unlocking actuator 125 to lock and unlock the door of the vehicle.

Under the control of the vehicle control ECU 124, the locking/unlocking actuator 125 locks and unlocks each door of the vehicle.

The portable keys 112-1 to 112-n are communication devices that are carried by the user and conduct wireless communication. When receiving the response request signal transmitted from the transmitter 131, the portable keys 112-1 to 112-n transmit the response signals.

Any number of portable keys 112-1 to 112-n may be provided. Hereinafter, the portable keys 112-1 to 112-n are simply referred to as a portable key 112 when there is no need to distinguish the portable keys 112-1 to 112-n from one another.

There is no particular limitation to a communication system between the wireless communication part 123 and the portable key 112, but any communication system may be adopted.

### Configuration Example of Transmitter 131

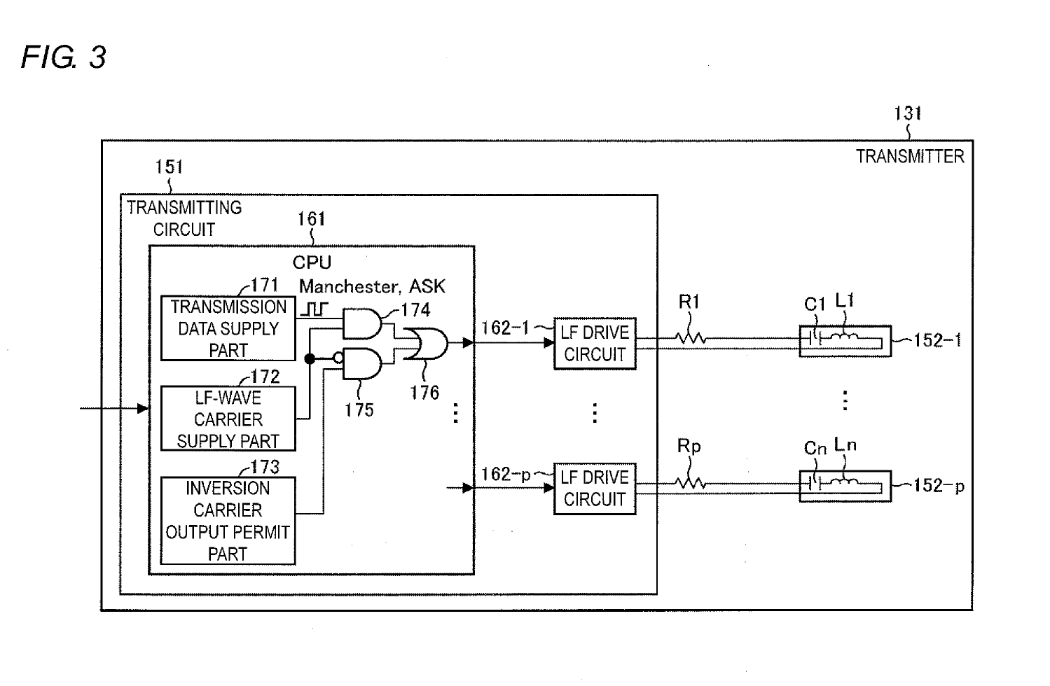

FIG. 3 is a block diagram illustrating a detailed configuration example of the transmitter 131 in FIG. 2. The transmitter 131 includes a transmitting circuit 151, LF antennas 152-1 to 152-p, and resistors R1 to Rp. The transmitting circuit 151 includes a CPU 161 and LF drive circuits 162-1 to 162-p.

Under the control of the controller 122, the CPU 161 executes a predetermined control program to implement functions including a transmission data supply part 171, an LF-wave carrier supply part 172, an inversion carrier output permit part 173, an AND gate 174, an AND gate 175, and an OR gate 176.

The transmission data supply part 171 supplies transmission data, which is transmitted together with the response request signal, to the AND gate 174. For example, the transmission data is modulated by Manchester encoding and ASK (Amplitude Shift Keying), and a transmission rate of the transmission data is set to 3900 bps (bits per second), for example.

The LF-wave carrier supply part 172 supplies a carrier wave that is of a pulse signal having a predetermined frequency (for example, 125 kHz) to the AND gate 174 and the AND gate 175. The carrier wave is inputted to the AND gate 175 while a phase of the carrier wave is inverted. That is, the carrier waves having the same frequency and the phases opposite each other are inputted to the AND gate 174 and the AND gate 175, respectively.

Hereinafter, the carrier wave in which the phase is inverted is referred to as an inversion carrier wave.

The inversion carrier output permit part 173 supplies an inversion carrier output permit signal to the AND gate 175 to control the inversion carrier wave outputted from the AND gate 175. For example, the inversion carrier output permit signal is set to high when the inversion carrier wave is permitted to be outputted from the AND gate 175, and the inversion carrier output permit signal is set to low when the inversion carrier wave is not permitted to be outputted.

The AND gate 174 calculates a logical product of the transmission data and the carrier wave to generate a modulated signal, in which the carrier wave is modulated by the transmission data, and supplies the modulated signal to the OR gate 176.

The AND gate 175 supplies a signal, which is generated by calculating a logical product of the inversion carrier wave and the inversion carrier output permit signal, to the OR gate 176. Accordingly, the AND gate 175 supplies the inversion carrier wave to the OR gate 176 when the inversion carrier output permit signal is high, and the AND gate 175 does not supply the inversion carrier wave to the OR gate 176 when the inversion carrier output permit signal is low.

The OR gate 176 obtains a signal (hereinafter, referred to as an input signal) by calculating a logical sum of the modulated signal supplied from the AND gate 174 and the signal supplied from the AND gate 175, and the OR gate 176 selects one of the LF drive circuits 162-1 to 162-p, and supplies the input signal to the selected LF drive circuit.

Thus, the CPU 161 controls the modulated signal and the inversion carrier wave, which are supplied to the LF drive circuits 162-1 to 162-p.

The LF drive circuits 162-1 to 162-p are driven based on the input signal supplied from the OR gate 176, and radio waves are radiated from the LF antennas 152-1 to 152-p based on the input signal. Therefore, the response request signal is transmitted from the transmitting circuit 151 to the portable keys 112-1 to 112-p through the LF antennas 152-1 to 152-p.

The LF antenna 152-i (i is natural numbers of 1 to p) includes a resonant circuit in which a capacitor Ci and a coil Li are connected in series, and the LF antenna 152-i is connected to the LF drive circuit 162-i through the resistor Ri.

Hereinafter, the LF drive circuits 162-1 to 162-p are simply referred to as an LF drive circuit 162 when there is no need to distinguish the LF drive circuits 162-1 to 162-p from one another. Hereinafter, the LF antennas 152-1 to 152-p are simply referred to as a LF antenna 152 when there is no need to distinguish the LF antennas 152-1 to 152-p from one another. Hereinafter, the resistors R1 to Rp, the capacitors C1 to Cp, and the coils L1 to Lp are simply referred to as a resistor R, a capacitor C, and a coil L, respectively, when there is no need to distinguish each of the resistors R1 to Rp, the capacitors C1 to Cp, and the coils L1 from one another.

### Example of Installation Position of LF Antenna 152

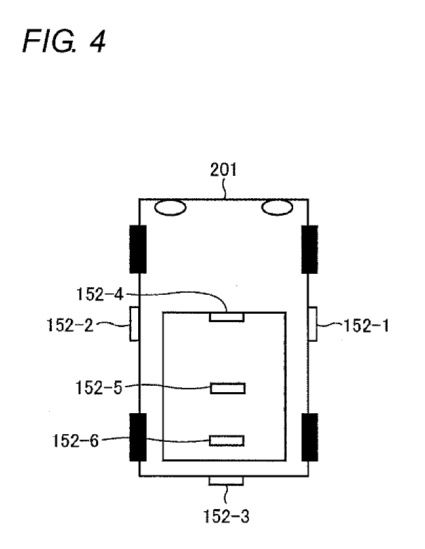

FIG. 4 illustrates an example of an installation position of the LF antenna 152. In the example in FIG. 4, six LF antennas 152-1 to 152-6 are installed in a vehicle 201.

For example, the LF antenna 152-1 is provided outside the door on the driver's seat side in order to detect the portable key 112 located outside the vehicle 201 on the driver's seat side. For example, the LF antenna 152-2 is provided outside the door on the assistant driver's seat side in order to detect the portable key 112 located outside the vehicle 201 on the assistant driver's seat side. For example, the LF antenna 152-3 is provided outside the rear door in order to detect the portable key 112 located outside the rear of the vehicle 201.

For example, the LF antenna 152-4 is provided in the indoor front in order to detect the portable key 112 located near the front seats (driver's seat and assistant driver's seat) of the vehicle 201. For example, the LF antenna 152-5 is provided in the indoor center in order to detect the portable key 112 located near the rear seat of the vehicle 201. For example, the LF antenna 152-6 is provided in the trunk room in order to detect the portable key 112 located in the trunk room of the vehicle 201.

### Transmission Timing of Response Request Signal and Response Signal

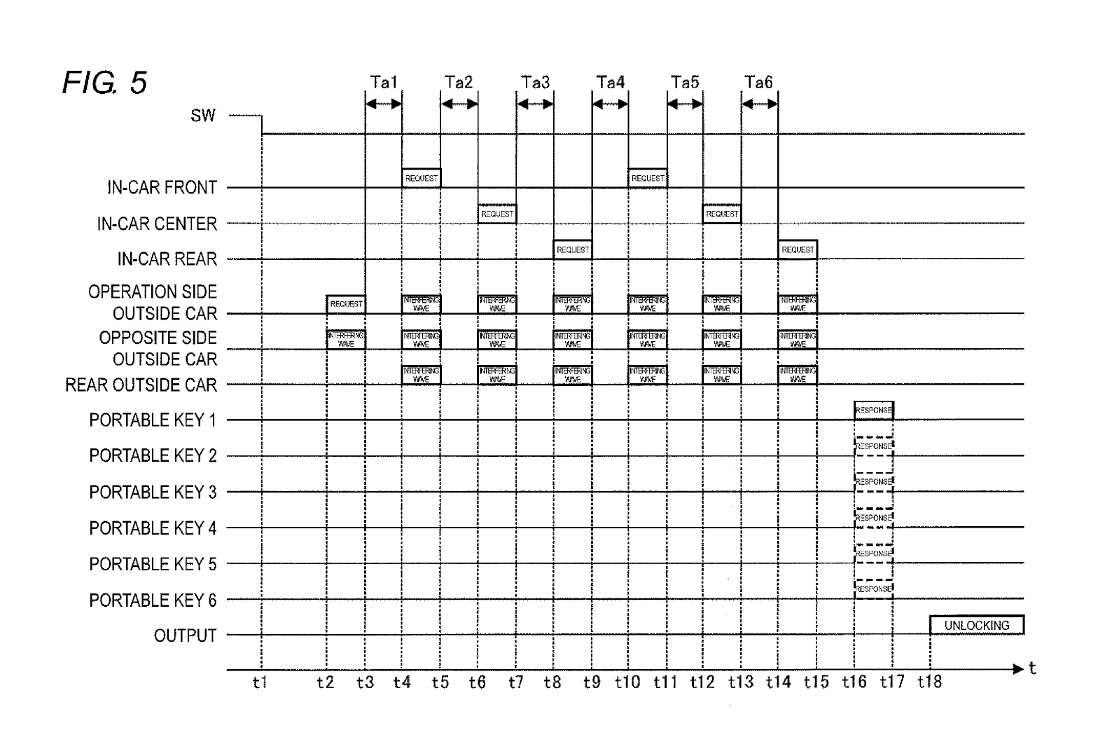

FIG. 5 illustrates an example of transmission timing of the response request signal and the response signal when the user makes a request to unlock the door using the portable key 112 in the case that the LF antennas 152-1 to 152-6 are installed in the vehicle 201 as illustrated in FIG. 4.

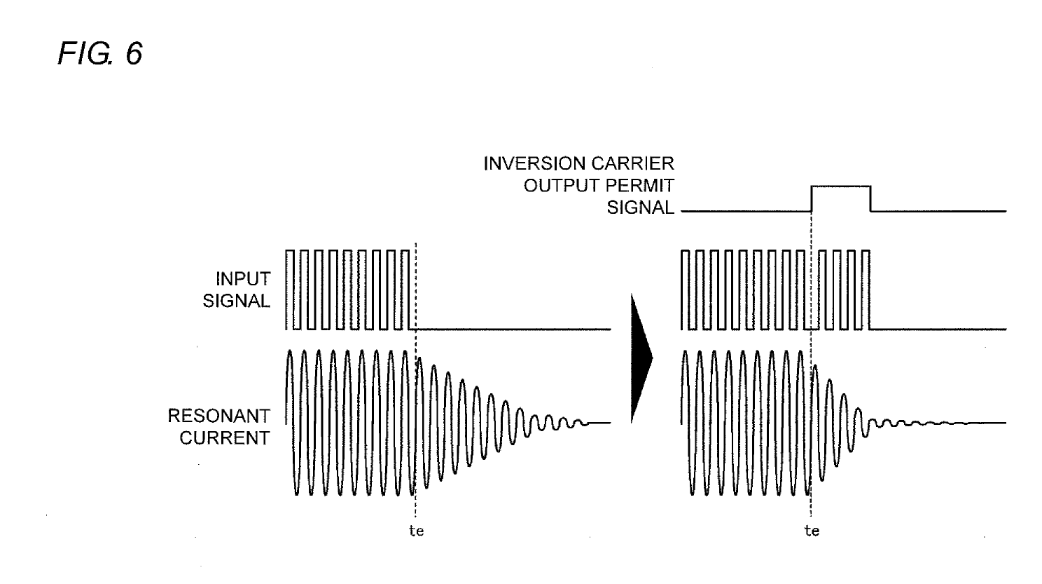

In the example in FIG. 6, the six portable keys 112-1 to 112-6 (portable keys 1 to 6 in FIG. 5) are provided in the passive entry system 101.

In FIG. 5, a time series progresses from the left toward the right as illustrated by an arrow in the lowermost stage. In FIG. 5, each stage indicates transmission timing of a signal. More particularly, a period described in a term of “request” indicates a transmission period of the response request signal, and a period described in “response” indicates a transmission period of the response signal. A period described in “interfering wave” indicates a transmission period of an interfering wave that prevents the portable key 112 located out of a possible detection area of each LF antenna 152 from receiving the response request signal. A period described in “unlock” indicates an output period of an unlocking command signal that orders the unlocking of the door.

The stage of “SW” indicates output timing of the operation signal of the locking/unlocking switch 121. When the user operates one of the locking/unlocking switches 121 to unlock the door of the vehicle 201, the operation signal outputted from the operated locking/unlocking switch 121 becomes from high to low at a clock time t1. When the operation signal of the locking/unlocking switch 121 becomes low, the controller 122 issues a command to the CPU 161 of the transmitter 131 to transmit the request response signal. Therefore, door unlocking processing is started.

The stage of “in-car front” indicates transmission timing of the response request signal that is transmitted from the LF antenna 152-4 to the indoor front (near the driver's seat and the assistant driver's seat) of the vehicle 201.

The stage of “in-car center” indicates transmission timing of the response request signal that is transmitted from the LF antenna 152-5 to the indoor center (near the rear seat) of the vehicle 201.

The stage of “in-car rear” indicates transmission timing of the response request signal that is transmitted from the LF antenna 152-6 to the rear trunk room of the vehicle 201.

The stage of “operation side outside car” indicates transmission timing of the response request signal and the interfering wave, which are transmitted from one of the LF antenna 152-1 and the LF antenna 152-2 on the side on which the locking/unlocking switch 121 is operated (hereinafter, referred to as an operation side) to the outside on the operation side of the vehicle 201.

The stage of “opposite side outside car” indicates transmission timing of the response request signal and the interfering wave, which are transmitted from one of the LF antenna 152-1 and the LF antenna 152-2 on the opposite side to the operation side to the outside on the opposite side to the operation side of the vehicle 201.

The stage of “rear outside car” indicates transmission timing of the interfering wave that is transmitted from the LF antenna 152-3 to the outside of the rear of the vehicle 201.

The stages of “portable key 1” to “portable key 6” indicate transmission timing of the response signals that are transmitted from the portable keys 112-1 to 112-6, respectively.

The stage of “output” indicates output timing of the unlocking command signal, which is outputted from the controller 122 when the controller 122 issues the command to the vehicle control ECU 124 to unlock the door locking/unlocking switch 121.

As illustrated in FIG. 5, the response request signals are transmitted from the LF antennas 152 at different times so as not to collide with each other. The response request signals are transmitted twice from the in-car LF antennas 152-4 to 152-6 such that the portable key 112 can surely receive the response request signal.

Specifically, in a period of a clock time t2 to a clock time t3, the response request signal is transmitted from the LF antenna 152 on the operation side outside the car. The interfering wave is transmitted from the LF antenna 152 on the opposite side outside the car such that the portable key 112 located outside the car on the opposite side to the operation side of the vehicle 201 does not receive the response request signal.

After a waiting period Tal waiting for fall of the response request signal transmitted from the LF antenna 152 on the operation side outside the car elapses, in a period of a clock time t4 to a clock time t5, the first response request signal is transmitted from the LF antenna 152-4 in the in-car front. The interfering waves are transmitted from the LF antennas 152-1 to 152-3 such that the portable key 112 located outside the car does not receive the response request signal.

After a waiting period Ta2 waiting for the fall of the response request signal transmitted from the LF antenna 152-4 elapses, in a period of a clock time t6 to a clock time t7, the first response request signal is transmitted from the LF antenna 152-5 in the in-car center. The interfering waves are transmitted from the LF antennas 152-1 to 152-3 such that the portable key 112 located outside the car does not receive the response request signal.

After a waiting period Ta3 waiting for the fall of the response request signal transmitted from the LF antenna 152-5 elapses, in a period of a clock time t8 to a clock time t9, the first response request signal is transmitted from the LF antenna 152-6 in the in-car rear, The interfering waves are transmitted from the LF antennas 152-1 to 152-3 such that the portable key 112 located outside the car does not receive the response request signal.

After a waiting period Ta4 waiting for the fall of the response request signal transmitted from the LF antenna 152-6 elapses, in a period of a clock time t10 to a clock time t11, the second response request signal is transmitted from the LF antenna 152-4 in the in-car front. The interfering waves are transmitted from the LF antennas 152-1 to 152-3 such that the portable key 112 located outside the car does not receive the response request signal.

After a waiting period Ta4 waiting for the fall of the response request signal transmitted from the LF antenna 152-4 elapses, in a period of a clock time t12 to a clock time t13, the second response request signal is transmitted from the LF antenna 152-5 in the in-car center. The interfering waves are transmitted from the LF antennas 152-1 to 152-3 such that the portable key 112 located outside the car does not receive the response request signal.

After a waiting period Ta6 waiting for the fall of the response request signal transmitted from the LF antenna 152-5 elapses, in a period of a clock time t14 to a clock time t15, the second response request signal is transmitted from the LF antenna 152-6 in the in-car rear. The interfering waves are transmitted from the LF antennas 152-1 to 152-3 such that the portable key 112 located outside the car does not receive the response request signal.

When one of the portable keys 112-1 to 112-6 receives one of the response request signals, the portable key 112 that receives the response request signal transmits the response signal in a period of a clock time t16 to a clock time t17.

When receiving the response signal from the portable key 112 through the receiver 132, the controller 122 determines whether the portable key 112 that transmits the response signal is located on the outside or the inside of the car based on the received response signal. When the portable key 112 that transmits the response signal is located on the outside of the car, the controller 122 starts the supply of the unlocking command signal, which orders the unlocking of the door on the operation side, to the vehicle control ECU 124 at a clock time t18.

The vehicle control ECU 124 to which the unlocking command signal is supplied controls the locking/unlocking actuator 125 to unlock the door on the operation side. Accordingly, in the case that the locking/unlocking switch 121 is operated, the door on the operation side is unlocked when the portable key 112 is detected outside the car. On the other hand, in the case that the locking/unlocking switch 121 is operated, the door is not unlocked when the portable key 112 is detected only in the car or when the portable key 112 is not detected.

Desirably a response time until the door is actually unlocked since the user makes the request to unlock the door is shortened. When the response time is lengthened, the user waiting time is lengthened to possibly give an uncomfortable feeling. Accordingly, it is desirable that the time until the unlocking of the door is actually started at the clock time t18 since the locking/unlocking switch 121 is operated at the clock time t1 is shortened.

For this purpose, in the passive entry system 101, the response time of the passive entry is shortened by shortening the waiting periods Tal to Ta6 in each of which the response request signal falls.

### Method for Shortening Response Time of Passive Entry

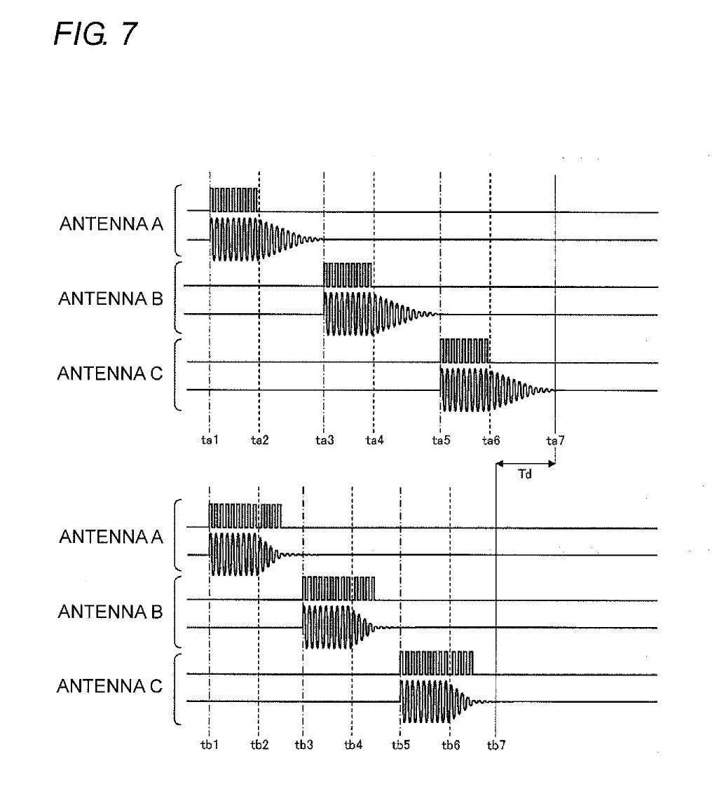

A method for shortening the response time of the passive entry in the passive entry system 101 will be described below with reference to FIGS. 6 and 7.

FIG. 6 is a view illustrating a comparison of the input signal supplied to the LF drive circuit 162 and a resonant current passing through the LF antenna 152 between the control performed by the same method as the conventional passive entry system and the control performed by the control method according to one or more embodiments of the present invention when the transmission of the response request signal is terminated. The left side in FIG. 6 illustrates an example of the waveform in the control performed by the conventional control method, and the right side illustrates an example of the waveform in the control performed by the control method according to one or more embodiments of the present invention.

In the case that the response request signal has the value of 1 (high) at a clock time to immediately before the transmission of the response request signal is terminated, the modulated signal identical to the carrier wave is supplied as the input signal to the LF drive circuit 162 to drive the LF drive circuit 162. Therefore, in synchronization with the input signal (=carrier wave), the resonant current having the same frequency as the carrier wave passes from the LF drive circuit 162 to the LF antenna 152 through the resistor R.

In the conventional control method, the supply of the input signal to the LF drive circuit 162 is stopped after the response request signal is transmitted (after the clock time te). Therefore, the resonant current passing through the LF antenna 152 attenuates gradually by action of the resistor R, and finally becomes zero. The time necessary for convergence of the resonant current is substantially equal to the time necessary for the fall of the response request signal.

On the other hand, in the control method according to one or more embodiments of the present invention, the inversion carrier output permit part 173 switches the inversion carrier output permit signal from low to high only for a predetermined period since the clock time te at which the transmission of the response request signal is terminated. As a result, the AND gate 175 outputs the inversion carrier wave for the predetermined period since the clock time te. On the other hand, the transmission data supply part 171 stops the output of the transmission data (the value of the transmission data becomes zero) on the termination of the transmission of the response request signal. As a result, the AND gate 174 stops the output of the modulated signal.

Therefore, the OR gate 176 supplies the inversion carrier wave to the LF drive circuit 162 for the predetermined period since the clock time te. Accordingly, the LF drive circuit 162 is driven until the clock time te based on the same modulated signal as the carrier wave, while the LF drive circuit 162 is driven for the predetermined period since the clock time te based on the inversion carrier wave having the opposite phase of the carrier wave.

Therefore, the attenuation of the resonant current passing through the LF antenna 152 is accelerated to shorten the convergence time of the resonant current, thereby shortening the time necessary for the fall of the response request signal.

FIG. 7 is a view schematically illustrating waveforms of the signals inputted to the LF drive circuits 162 and the resonant current passing through the LF antennas 152 between the conventional control method and the control method according to one or more embodiments of the present invention when the three LF antennas 152 of antennas A to C sequentially transmit the response request signals. The upper side in FIG. 7 illustrates an example of the waveform in the control performed by the conventional control method, the lower side illustrates an example of the waveform in the control performed by the control method according to one or more embodiments of the present invention.

As illustrated in the graph on the upper side in FIG. 7, in the conventional control method, the supply of the input signal to the LF drive circuit 162 for the antenna A is started at a clock time ta1. Therefore, the passage of the resonant current through the antenna A is started, and the transmission of the response request signal from the antenna A is started. At a clock time tat, the supply of the input signal to the LF drive circuit 162 for the antenna A is stopped, and the resonant current passing through the antenna A attenuates gradually.

The resonant current of the antenna A converges to a predetermined level, and the response request signal transmitted from the antenna A falls. Then, the supply of the input signal to the LF drive circuit 162 for the antenna B is started at a clock time ta3. Therefore, the passage of the resonant current through the antenna B is started, and the transmission of the response request signal from the antenna B is started. At a clock time ta4, the supply of the input signal to the LF drive circuit 162 for the antenna B is stopped, and the resonant current passing through the antenna B attenuates gradually.

The resonant current of the antenna B converges to a predetermined level, and the response request signal transmitted from the antenna B falls. Then, the supply of the input signal to the LF drive circuit 162 for the antenna C is started at a clock time ta5. Therefore, the passage of the resonant current through the antenna C is started, and the transmission of the response request signal from the antenna C is started. At a clock time ta6, the supply of the input signal to the LF drive circuit 162 for the antenna C is stopped, and the resonant current passing through the antenna C attenuates gradually. At a clock time ta7, the resonant current passing through the antenna C converges to a predetermined level.

On the other hand, as illustrated in the graph on the lower side in FIG. 7, in the control method according to one or more embodiments of the present invention, the supply of the input signal to the LF drive circuit 162 for the antenna A is started at a clock time tb1. Therefore, the passage of the resonant current through the antenna A is started, and the transmission of the response request signal from the antenna A is started. At a clock time tb2, the supply of the input signal to the LF drive circuit 162 for the antenna A is stopped, and for a predetermined period since the clock time tb2, the inversion carrier wave is supplied to the LF drive circuit 162 for the antenna A. Therefore, the resonant current passing through the antenna A attenuates earlier than the conventional control method.

The resonant current of the antenna A converges to a predetermined level, and the response request signal transmitted from the antenna A falls. Then, the supply of the input signal to the LF drive circuit 162 for the antenna B is started at a clock time tb3. Therefore, the passage of the resonant current through the antenna B is started, and the transmission of the response request signal from the antenna B is started. At a clock time tb4, the supply of the input signal to the LF drive circuit 162 for the antenna B is stopped, and for a predetermined period since the clock time tb4, the inversion carrier wave is supplied to the LF drive circuit 162 for the antenna B. Therefore, the resonant current passing through the antenna B attenuates earlier than the conventional control method.

The resonant current of the antenna B converges to a predetermined level, and the response request signal transmitted from the antenna B falls. Then, the supply of the input signal to the LF drive circuit 162 for the antenna C is started at a clock time tb5. Therefore, the passage of the resonant current through the antenna C is started, and the transmission of the response request signal from the antenna C is started. At a clock time tb6, the supply of the input signal to the LF drive circuit 162 for the antenna C is stopped, and for a predetermined period since the clock time tb6, the inversion carrier wave is supplied to the LF drive circuit 162 for the antenna C. Therefore, the resonant current passing through the antenna C attenuates earlier than the conventional control method.

According to the control method according to one or more embodiments of the present invention, the convergence of the resonant current passing through each antenna is accelerated compared with the conventional control method. Accordingly, the waiting time until the transmission of the response request signal from the next antenna is started since the transmission of the response request signal from one antenna is terminated can be shortened. As a result, the time until the response request signal from the antenna C falls since the transmission of the response request signal from the antenna A is started can be shortened by a time Td in FIG. 7.

Therefore, the passive entry response time until the door is actually unlocked since the user operates the locking/unlocking switch 121 can be shortened to prevent the lengthened waiting time from giving user the uncomfortable feeling.

One or more embodiments of the present invention will be described below.

One or more embodiments of the present invention is advantageously applied to not only the case that the plurality of LF antennas 152 transmits the response request signals, but also the case that one LF antenna 152 continuously transmits the response request signal. Specifically, for example, one or more embodiments of the present invention can advantageously applied to the case that the same LF antenna 152 continuously transmits the response request signal by waiting for the convergence of the response request signal after the response request signal is transmitted from the LF antenna 152.

One or more embodiments of the present invention can advantageously be applied to not only the case that the plurality of LF antennas 152 transmit the same type of the signal, but also the case that the plurality of LF antennas 152 transmit the different types of the signal at different times. Similarly, one or more embodiments of the present invention can advantageously be applied to the case that one LF antennas 152 continuously transmits the different types of the signal.

Further, the configuration of the transmitting circuit 151 is not limited to the example. For example, some of or all the functions of the CPU 161 in FIG. 3 may be constructed by hardware. For example, the controller 122 may perform some of or all the functions of the CPU 161, or the CPU 161 may perform some of the functions of the controller 122. For example, the LF drive circuit 162 may generate the inversion carrier wave by the command issued from the CPU 161. For example, each one of the AND gates 174 to OR gates 176 may be provided with respect to the LF drive circuit 162.

In the foregoing description, the door is unlocked by way of example. However, one or more embodiments of the present invention can also be applied to other operations, such as the locking of the door.

In addition to the passive entry system, one or more embodiments of the present invention can be applied to a system, in which the response request signal is transmitted from the vehicle side and the response signal is transmitted from the portable key to the response request signal to perform some sort of processing.

In the specification, the system means a set of a plurality of structural elements (such as a device and module (component)), and whether all the structural elements are accommodated in the same chassis is out of the question.

The present invention is not limited to the above embodiments, but various changes can be made without departing from the scope of the present invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A wireless communication device for a vehicle that conducts wireless communication with a vehicle portable key through an antenna including a resonant circuit, the wireless communication device comprising:
a transmitting circuit that transmits a signal from the antenna; and
a control circuit that supplies an inversion carrier wave in which a phase of a carrier wave is inverted to the transmitting circuit for a predetermined time after a modulated signal in which the carrier wave is modulated by transmission data is transmitted from the antenna.

2. A wireless communication device for a vehicle that conducts wireless communication with a vehicle portable key through a first antenna including a first resonant circuit and a second antenna including a second resonant circuit, the wireless communication device comprising:
a transmitting circuit that transmits a signal from the first antenna and the second antenna; and
a control circuit that supplies an inversion carrier wave in which a phase of a carrier wave is inverted to the transmitting circuit for a predetermined time after a modulated signal in which the carrier wave is modulated by transmission data is transmitted from the first antenna and the second antenna,
wherein the wireless communication device transmits the modulated signal at different times through the first antenna and the second antenna, and
wherein the control circuit supplies the inversion carrier wave to the transmitting circuit for the first antenna for a predetermined time before the modulated signal is transmitted through the second antenna after the modulated signal is transmitted through the first antenna.

3. The wireless communication device according to claim 1, wherein the control circuit generates the modulated signal and the inversion carrier wave in which a phase of the carrier wave is inverted, and supplies the modulated signal and the inversion carrier wave to the transmitting circuit.

4. The wireless communication device according to claim 1, wherein the transmitting circuit generates the inversion carrier wave in response to a command from the control circuit.

5. The wireless communication device according to claim 1, further comprising the antenna.

6. A communication control method for a wireless communication device for a vehicle, comprising:
transmitting a signal via a transmitting circuit from an antenna including a resonant circuit;
conducting wireless communication with a vehicle portable key through the antenna; and
supplying an inversion carrier wave in which a phase of a carrier wave is inverted to the transmitting circuit for a predetermined time after a modulated signal in which the carrier wave is modulated by transmission data is transmitted from the antenna.

7. The wireless communication device according to claim 2, wherein the control circuit generates the modulated signal and the inversion carrier wave in which a phase of the carrier wave is inverted, and supplies the modulated signal and the inversion carrier wave to the transmitting circuit.

8. The wireless communication device according to claim 2, wherein the transmitting circuit generates the inversion carrier wave in response to a command from the control circuit.

9. The wireless communication device according to claim 3, further comprising the antenna.

10. The wireless communication device according to claim 4, further comprising the antenna.

11. The wireless communication device according to claim 2, further comprising the first antenna and the second antenna.

12. The wireless communication device according to claim 7, further comprising the first antenna and the second antenna.

13. The wireless communication device according to claim 8, further comprising the first antenna and the second antenna.
